(19) United States
(12) Patent Application Publication
(10) Pub. No.: US 2024/0362973 A1
(43) Pub. Date: Oct. 31, 2024

(54) SYSTEM AND METHOD FOR COMPUTATIONALLY EFFICIENT AUTOMATED SETTLEMENT OF BETS IN SPORTS GAMBLING PLATFORMS

(71) Applicant: Richard Olaniyi Owoyemi, Rosedale, MD (US)

(72) Inventor: Richard Olaniyi Owoyemi, Rosedale, MD (US)

(21) Appl. No.: 18/764,528

(22) Filed: Jul. 5, 2024

Related U.S. Application Data
(63) Continuation-in-part of application No. 18/104,374, filed on Feb. 1, 2023.
Application No. 18/104,374 is a continuation of application No. PCT/US22/50511, filed on Nov. 19, 2022.
(60) Provisional application No. 63/343,867, filed on May 19, 2022.
(60) Provisional application No. 63/331,856, filed on Apr. 17, 2022.

(51) Int. Cl. G07F 17/32

(52) U.S. Cl. CPC G07F 17/3244; G07F 17/3288

(57) ABSTRACT

A system and a method for computationally efficient automated settlement of bets between one or more users, such as in a sports gambling platform, is disclosed. The system generates contests associated with one or more events and transmits the contests to user devices. The system receives electronic bet slips having predicted outcomes and odds value therefore selected/determined by users operating the user devices. The system reduces computational load by adjusting odds value based on selections/determinations of the odds value by the users, instead of determining the odds value based on diverse and complex datasets using complex algorithms as are used in existing fixed-odds betting solutions. The system tracks real-time event outcomes and calculates final odds based on the predicted outcomes matching the actual outcome. The system ranks the users based on their final odds values, and executes payouts to users whose ranks satisfy a prize rank position.

### CROSS-REFERENCE TO RELATED APPLICATIONS

This application is a Continuation-in-part of U.S. Non-provisional application Ser. No. 18/104,374 filed on Feb. 1, 2023, which in turn is a Continuation of PCT Application No. PCT/US22/50511 filed on Nov. 19, 2022 that claims priority to U.S. Provisional Application 63/331,856 filed on Apr. 17, 2022, and U.S. Provisional Application 63/343,867 filed on May 19, 2022. The content of each of the above applications is hereby expressly incorporated by reference herein in its entirety.

### FIELD OF DISCLOSURE

The present disclosure relates to gaming systems/apparatus with financial rewards. More particularly, the present disclosure relates to a system and a method for computationally efficient automated settlement of bets, in a peer-to-peer betting environment.

### BACKGROUND

Sports betting has become a trendy way of earning money in the fast-paced gambling industry, providing entertainment and increasing viewership to sports fans and spectators. Sports betting uses sports like football, soccer, horse or dog racing, basketball, and the like, for contests against the house or amongst multiple sports bettors while utilizing online or offline distribution channels. In sports betting, the bettors predict outcomes of a game (such as winners) and place a wager on the game's outcome. One type of sports betting that involves competition between multiple sports bettors is ‘Daily Fantasy Sports’ which mirrors season-long fantasy sports, but condenses it into a shorter one whereby the users draft a player roster. Those athletes earn points based on their in-game performance. Winners are then decided based on the ranking of the cumulative points scored among the users. This approach involves player performance instead of odds selections, making a cross-play to widespread sports betting formats involving fixed-odds bet slips unattainable. Parlay is a type of fixed-odds betting where bettors select multiple outcomes to form a betting slip. This slip is used to compete against the house. The bettor wins only if all their predicted outcomes are accurate. However, many users become frustrated due to the difficulty in correctly predicting all the multiple outcomes in a parlay bet slip.

Moreover, the heightened interest in parlay betting necessitates the need for a computationally efficient automated settlement system. This system would calculate odds for peer-to-peer bets by receiving bet slips from users, determining actual outcomes of the games, and executing payouts based on correctly predicted outcomes. Such a system would benefit not only users but also the computing infrastructures supporting this emerging form of entertainment. The volume of games that such a system would track, similar to a fixed odds betting system, has increased so much that it's impractical to use humans to calculate odds, particularly in real-time. Moreover, it's also impractical to have humans to receive and process bet slips from thousands of bettors in real-time. While digitization of the betting has allowed for the determination of such high volumes of odds values and processing of bet slips, existing fixed-odds betting systems do so inefficiently.

For example, as shown in flowchart 100 of FIG. 1, existing fixed odds betting systems, at step 102, may allow users to place parlay bets on one or more events, such as 4 football games. Such systems use complex algorithms to determine the odds value for each event. Such algorithms typically have at least a polynomial complexity, given they require calculations of conditional probabilities of occurrence of an event. Some algorithms may also include constraints that enable the house to ensure profits. Additionally, large and complex datasets may be required for determining the odds such as for training the machine learning models, or performing trend analysis using statistical models, for determining odds in a manner that protects operator liability. Such odds determinations have to be performed in real-time. Such algorithms may determine the odds for each outcome of the event to be as follows:
Chelsea (Home win): 1.54, Brighton (Away win): 2.00, Draw: 4.00
Man Utd (Home win): 1.80, Newcastle (Away win): 2.30, Draw: 3.00
Tottenham (Home win): 1.30, Sheff Utd (Away win): 1.80, Draw: 6.00
Man City (Home win): 1.20, West Ham (Away win): 20.00, Draw: 12.00

The user may decide to create an accumulator bet on Chelsea, Man Utd, Tottenham, and Man City all to win. The user enters a stake/entry fee of $10, and transmits the bet to the existing betting systems. The potential winnings in such cases may be determined to be $43.24 (i.e. 1.54*1.80*1.30*1.20*$10). At step 104, the existing fixed odds betting systems receives the bets from the users, and determines/verifies actual outcomes of each event in steps 106 to 112. Existing fixed odds betting systems perform verifications for all the events on a bet slip, even after the outcome of the bet slip has been determined. For example, existing fixed odds betting systems may still perform steps 108 to 112, even if the predicted outcome for the first event is false (such as when the user predicts Chelsea to win in the first event, but ends in a draw), thereby leading to potentially redundant computational expenditure.

At step 114, the existing fixed odds betting systems determine if any of the predicted outcomes are false. If no, at step 118, payouts are provided as equivalent to the potential payouts (i.e. $43.23). If yes, at step 116, the odds for the incorrectly predicted outcome are set to 0. This invalidates the value of any correct odds and results in potential payouts being equivalent to $0. In such cases, although steps 108 to 112 are performed, such computation is redundant as it is never utilized. Aside from wastage of computational resources, existing fixed odds betting systems are also memory inefficient as outcomes of each event have to be stored in memory, even when such outcomes are not required to determine the payouts as soon as one of the predicted outcomes is determined to be false.

Therefore, there is a need for a computationally efficient system and a method for automated settlement of bets.

### SUMMARY

An aspect of the present disclosure is directed towards a system for automated settlement of peer-to-peer bets. The system includes a processor, and a memory operatively coupled to the processor, where the memory includes one or more processor-executable instructions. Execution of the processor-executable instructions cause the processor to generate one or more contests, where each contest is associated with one or more events, and synchronously transmit, over a communication network, the one or more contests to one or more user devices operated by one or more users for display on a user interface of the one or more user devices. The processor also receives, through the communication network, one or more electronic bet slips from the one or more user devices, where each of the one or more electronic bet slips includes a predicted outcome for a subset of events from the one or more events selected by the one or more users, and an odds value associated with the predicted outcome corresponding to the subset of events. On conclusion of each event from the one or more events, the processor is configured to determine an actual outcome of the event based on electronic representation of the event in real-time, and determine a final odds value for each of the one or more electronic bet slips based on the predicted outcome matching with the actual outcome of the one or more events. The processor is configured to assign a rank to the one or more users based on the final odds value of the one or more electronic bet slips corresponding to the one or more users, and execute a payout to a subset of users from the one or more users having the rank satisfying a prize paying position associated with the one or more contests.

Other aspects and advantages of the disclosure will become apparent from the following drawings, detailed descriptions, and claims, all of which illustrate the principles of the disclosure by way of example only.

### BRIEF DESCRIPTION OF DRAWINGS

The present disclosure will be described by way of exemplary embodiments, but not limitations, illustrated in the accompanying drawings in which like references denote similar elements, and in which:

FIG. 1 illustrates a flowchart of a method used by existing fixed odds betting systems.

FIG. 2A illustrates an exemplary architecture diagram of various components of a computationally efficient system for automated settlement of bets, according to embodiments of the present disclosure.

FIG. 2B illustrates a block diagram of the system, according to embodiments of the present disclosure.

FIG. 3A illustrates an example user interface showing a list of contests, according to embodiments of the present disclosure.

FIG. 3B illustrates an example user interface showing odds values of each outcome of one or more events associated with the contests, and predicted outcomes picked by the user, according to embodiments of the present disclosure.

FIG. 3C illustrates an example user interface showing whether the predicted outcome matches the actual outcomes of the events, according to embodiments of the present disclosure.

FIG. 4A illustrates an example table of one or more electronic bet slips placed by one or more users competing against each other, in accordance with embodiments of the present disclosure.

FIG. 4B illustrates an example table of bet slips placed by users belonging to one or more syndicates, according to embodiments of the present disclosure.

FIG. 4C illustrates an example table of standings of one or more users in a betting tournament, according to embodiments of the present disclosure.

FIG. 5 illustrates an example flowchart of a method for automated settlement of peer-to-peer bets, according to the embodiments of the present disclosure.

FIG. 6 illustrates an example computer system in which or with which embodiments of the system may be implemented, according to embodiments of the present disclosure.

### DETAILED DESCRIPTION

Throughout the specification, and the claims below, and in the accompanying drawings, reference is made to particular features of the present disclosure. It is to be understood that the present disclosure includes all possible combinations of such particular features. For example, where a particular feature is disclosed in the context of a particular aspect or embodiment of the present disclosure, or a particular claim, that feature can also be used, to the extent possible, in combination with and/or in the context of other particular aspects and embodiments of the present disclosure.

Where reference is made herein to a method including two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

“Exemplary” is used herein to mean “serving as an example, instance, or illustration.” Any aspect described in this document as “exemplary” is not necessarily to be construed as preferred or advantageous over other aspects.

Throughout the drawings, like reference numerals/characters are used to designate like elements. As used herein, the term “coupled” or “coupling” may indicate a connection. The connection may be a direct or an indirect connection between one or more items. Further, the term “set” as used herein may denote one or more of any items, so a “set of items” may indicate the presence of only one item or may indicate more items. Thus, the term “set” may be equivalent to “one or more” as used herein.

In the following detailed description, numerous specific details are set forth in order to provide a more thorough understanding of the one or more embodiments described herein. However, it will be apparent to one of ordinary skills in the art that the disclosure may be practiced without these specific details. In other instances, well-known features have not been described in detail to avoid unnecessarily complicating the description.

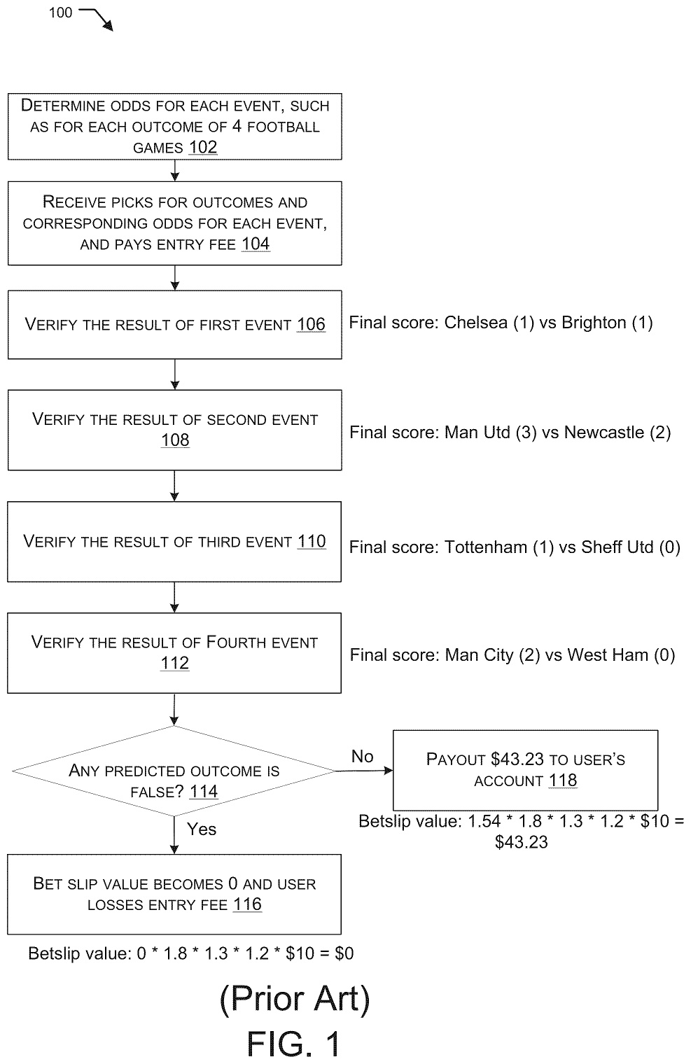

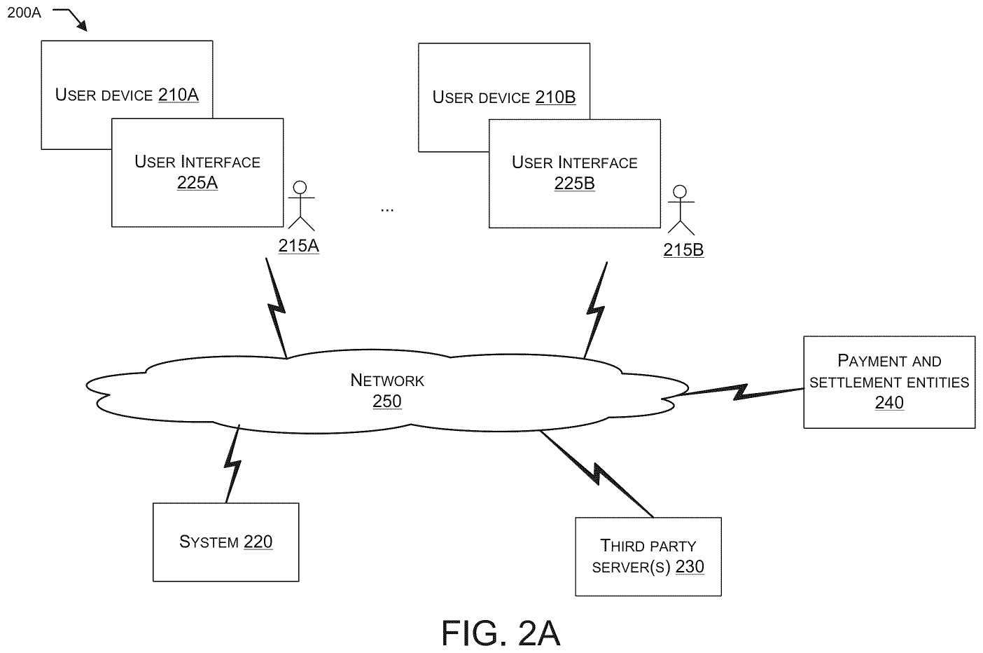

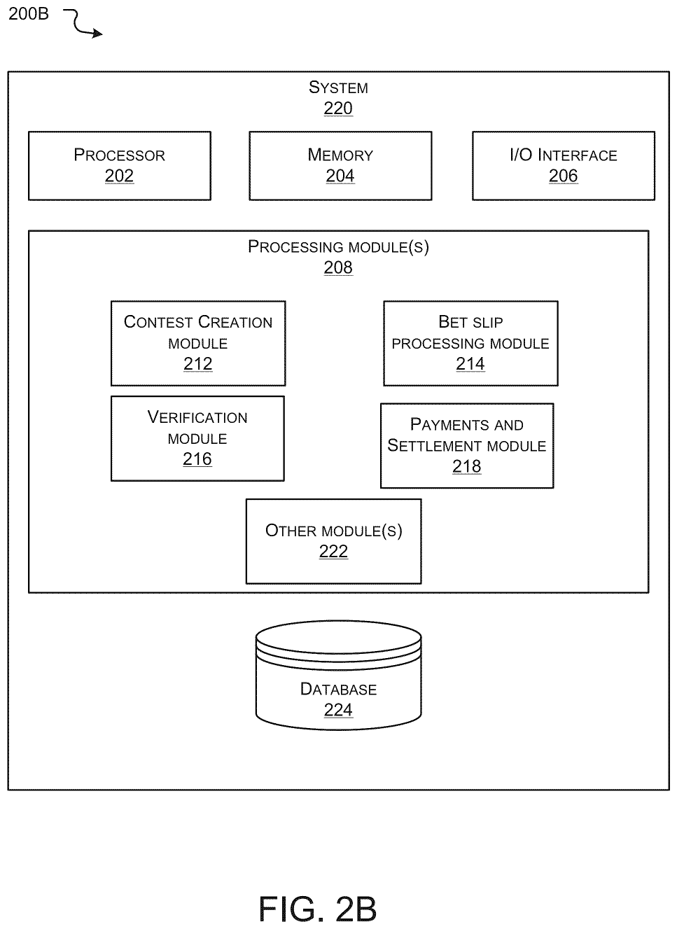

Turning to FIG. 2A, FIG. 2A depicts a block diagram of an embodiment of the present disclosure for an architecture 200A for settlement of bets. The architecture 200A may include a plurality of components associated therewith, such as user devices (210A, 210B), third-party servers 230, payment and settlement entities 240, and a system 220 for settlement of bets/betting odds between two or more users (215A, 215B). It may be appreciated that the user devices (210A, 210B) may be individually referred as the user device 210 or collectively referred as the user devices 210, and similarly the users (215A, 215B) may be referred as the user 215 or users 215, for the sake of brevity. The user devices 210 may be utilized by a corresponding user 215. The users 215 may be sports bettors or other types of bettors. Further, user devices 210 and users 215 may be located in various geographical locations that are either located apart or are located in proximity to each other. As used herein, the terms user and player may be used interchangeably. It may be appreciated that although two user devices 210 and two users 215 are depicted in FIG. 1, there may be any number of users 215 and user devices 210 interacting with the system 220 within the scope of the present disclosure.

Each of the user devices 210 may have a corresponding user interface (such as user interface 225A and 225B, which are collectively referred to as user interfaces 225) for displaying content related to the system 220 for automated settlement of bets. The user interfaces 225 may have a plurality of buttons or icons that are selectable through the user interface 225 for the system 220 to perform particular processes in response to the selections. In some embodiments, the user interface 225 may be implemented as a graphical user interface that includes title bars, toolbars, pull-down menus, tabs, scroll bars, content help, dialog boxes, operating buttons (icons), status bars that the user 215 navigates throughout the display, and the like. The display appears in the browser window with the toolbar. Toolbar buttons activate the functionality. Toolbar buttons are active/inactive depending upon the tab and functionality presented in a view. In some implementations, the display is separate from the user device 210, and in other implementations, the display may be integrated with input devices associated with the user interface 225 (such as in case of touchscreens). Examples of the display include, but are not limited to, a Liquid Crystal Display (LCD) screen, a Light Emitting Diode (LED) screen, a projector, holographic, virtual reality display, or augmented reality display (such as a heads-up display device or a head-mounted device), wearable device electronic glasses, contact lenses capable of computer-generated sensory input and displaying data, and so on.

The user devices 210 may be any type of computing device that typically operates under the control of one or more operating systems which control scheduling of tasks and access to system resources. The user device 210 may be a phone, tablet, television, desktop computer, laptop computer, gaming system, wearable device, electronic glasses, networked router, networked switch, networked bridge, or any computing device capable of executing instructions with sufficient processor power and memory capacity to perform operations. The user device 210 may have a transmitter to transmit the data. The transmitter may have a wired or wireless connection and may comprise a multi-band cellular transmitter to connect to the system 220 over 2G/3G/4G/5G/6G cellular networks. Other embodiments may also utilize Near Field Communication (NFC), Bluetooth, or a network 250 to connect to the system 220.

The architecture 200A also includes the payment and settlement entities 240 and the third-party servers 230. The payment and settlement entities 240 may be entities (or computing devices thereof) that allow for electronic settlement of financial transactions between two or more entities. For example, the payment and settlement entities 240 may facilitate the transfer of electronic representations of money (such as in the form of numeric representation of value associated with a banking account, digital currency, points, tokens, credits, cryptocurrency, and the like) between entities involved in the transaction, such as between the system 220 and the users 215. The users 215 may execute payments towards operators of the system 220 to pay entry fee to stake money for placing bets, and the system 220 may make payments to the users 215 who win bets. In some embodiments, the payment and settlement entities 240 may be implemented as a computing device or a server configured to facilitate/execute the transaction on receipt of signals (such as through Application Programming Interfaces (API) calls). In some embodiments, the payment and settlement entities 240 may also include an apparatus that dispenses physical currency or other tangible forms of value at designated locations. For instance, the payment and settlement entities 240 may be integrated with Automated Teller Machines (ATMs) or kiosks that allow users 215 to withdraw physical cash corresponding to the digital balance held in their accounts. Furthermore, these entities may support multiple payment methods including, but not limited to, contactless payments, mobile wallets, direct bank transfers, and traditional card-based transactions. To enhance security, the payment and settlement entities 240 may incorporate encryption techniques, tokenization, multi-factor authentication, and the like.

The third-party servers 230 may be servers operated by third-party entities, who may correspond to entities that aggregate one or more events. In some embodiments, the third-party entities may correspond to other fixed-odds betting systems that allow users to make selections and formulate a parlay bet slip. The system 220 may allow users 215 to transfer their bet slips, originally created for contests created by the third-part entities to vie against the house. Further, system 220 may provide users 215 access to bring their bet slips from third-party fixed odds systems to compete in a contest against other users 215. Third-party entities may also correspond to entities that report the actual outcomes of events. The third-party servers 230 may also be accessed through transmission of electronic signals, such as using APIs. The third-party servers 230 may allow for real-time exchange of data.

In some embodiments, the architecture 200A may include the system 220 for automated settlement of bets. The system 220 may be configured to facilitate the settlement of bets made for or against outcomes of events between two or more users 215. In some embodiments, the system 220 may be implemented as one or more servers. The user devices 210 may be in communication with the system 220 using one or more networks, such as the network 250. The system 220 may be located at a data center or any other location suitable for providing service to the network 250, whereby the system 220 may be in one central location or in many different locations in multiple arrangements. The system 220 may include a database server 224 (shown in FIG. 2B) such as MySQL® or Maria DB® server. The system 220 may have an attached data storage system storing software applications and data. In other embodiments, the system 220 may be implemented in the user device 210, such as in an application or as a payment-freed apparatus at any facility, such as in a casino or a bar. The system 220 may be implemented using any computing device.

Various components of the system 220 are described in detail in reference to block diagram 200B of FIG. 2B. The system 220 may include one or more processors 202, a memory 204, and an input/output (I/O) interface 206. The I/O interface 206 may allow inputs from operators of the system 220 to be received by the processor 202, or through input devices connected to the system 220. The input devices may be implemented as a keyboard, a touchscreen, a mouse, a microphone, a wearable input device, a camera, a trackball, a microphone, a fingerprint reader, an infrared port, a controller, a remote control, a fax machine, and combinations thereof. The input devices may also include remote communication devices that allow signals to be exchanged with other entities connected to the system 220 through the network 250. Other I/O devices may also be coupled to the processor 202, such as a network card, video card, audio card, Universal Serial Bus (USB), or other external device, camera, printer, speakers, Compact Discs (CDs), Digital Versatile Discs (DVDs), disk drive, or Blu-Ray device. In further non-limiting embodiments, a display may be used as an output device, such as, but not limited to, a computer monitor, a speaker, a television, a smart phone, a fax machine, a printer, or combinations thereof. Actions may be initiated by a hardware controller that interprets the signals received from input device and communicates the information to the processor 202 using a communication protocol. In embodiments where the system 220 is implemented as a server, the input devices may correspond to wires or cables that provide signals (having information/data embedded therein) to be communicated to the processor 202.

The processor 202 may be a single processing unit or multiple processing units in a device or distributed across multiple devices. The processor 202 may be implemented as one or more of including, but not limited to, microprocessors, microcomputers, microcontrollers, digital signal processors, central processing units, state machines, logic circuits, and any devices that manipulate data or signals based on operational instructions, and the like. The processor 202 may also be coupled to other hardware devices, such as one or more memory devices with the use of a bus, such as a Peripheral Component Interconnect (PCI) bus or Small Computer System Interface (SCSI) bus.

The processor 202 may have access to a memory, such as the memory 204. Among other capabilities, the processor 202 may fetch and execute processor-readable/processor-executable instructions in the memory 204 operationally coupled with the system 220 for performing tasks such as data processing, input/output processing, feature extraction, and/or any other functions. The memory 204 may include one or more of various hardware devices for volatile and non-volatile storage and may include both read-only and writable memory. For example, the memory 204 may include random access memory (RAM), Central Processing Unit (CPU) registers, read-only memory (ROM), and writable non-volatile memory, such as flash memory, hard drives, floppy disks, Compact Discs (CDs), Digital Versatile Discs (DVDs), magnetic storage devices, tape drives, device buffers, and so forth. In other implementations, the memory 204 may be a non-transitory memory such as an Erasable Programmable Read-Only Memory (EPROM), flash memory, and the like.

The memory 204 may include program memory capable of storing programs and software, including an operating system, such as operating system. The memory 204 may further include an API, and other computerized programs or application programs. Further, the memory 204 may also include data memory that may include database query results, configuration data, settings, user options, user preferences, or other types of data which may be provided to any element of the system 220.

The system 220 may have a number of processing modules 208 that provide various functions related to settlement of bets. The processing modules 208 may be implemented as a combination of hardware and software or computer programs, to implement one or more functionalities of the processing modules(s) 208. In examples described herein, such combinations of hardware and computer programs may be implemented in several different ways. For example, the computer programs for the processing modules(s) 208 may be processor-executable instructions stored on a non-transitory machine-readable storage medium and the hardware for the processing modules(s) 208 may include a processing resource (for example, one or more processors), to execute such instructions. The processing modules 208 may interact with the system 220 whereby data collected in databases as instruction-based expressions of components and/or processes may be processed by one or more processors 202 within the system 220 or another component of user devices 210 as well as in conjunction with execution of one or more other computer programs. The modules 208 may be configured to receive commands or requests from user devices 210, and outside connected devices over the network 250. The system 220 may include other components, subsystems, and modules to support one or more management services for settlement of bets. For example, the system 220 may include the processing modules 208 operative to maintain presence information for one or more users 215 and to provide chat functionality allowing users 215 to communicate messages in a chat through the system 220.

As shown, the system 220 may include, among others, a contest creation module 212, a bet slip processing module 214, a verification module 216, a payments and settlement module 218, and other modules 222. In some embodiments, the contest creation module 212 may be configured to generate or retrieve one or more contests from the third-party servers 230 where each contest is associated with one or more events. The bet slip processing module 214 may be configured to receive and process electronic bet slips received from the users 215. The verification module 216 may be configured to determine the actual outcome of events, and the payments and settlement module 218 may execute payouts to the users 215, as described subsequently in detail.

The other modules 222 may include an audio module and a video module, which receive and process audio and video data, respectively, from one or more connected video cameras or other input devices for the users 215 on the user devices 210. The audio module may include, among other modules or components for processing audio data, speech detection and recognition modules and codecs for processing incoming or outgoing video data. A speech detection module may be configured to detect instances of speech at a site (for example, to trigger recording or other functions of the system 220), and/or determine the relative physical location of the detected speech for use in controlling the operation of individual microphones on the user devices 210 or third-party servers 230. Speech recognition may be used to distinguish between individual voices for the purpose of filtering out other voices. In some embodiments, the audio module may be used to determine actual outcome of all events from an audio feed thereof.

The video module may include image recognition modules for use in detecting speech or distinguishing between announcers or other individuals, and appropriate codecs for use in processing incoming or outgoing video data. The image recognition modules may include face tracking or pattern recognition algorithms to identify the users 215. In some embodiments, the video module may be used to determine actual outcome of all events from a live video feed thereof. The audio and video modules may also include, respectively, interfaces for data communication between input units such as microphones and cameras, and output units such as speakers and display screens, or may be configured to receive the live audio or video feed from the third-party servers 230. The selection and implementation of appropriate speech and video modules, including codecs and speech detection/recognition modules, image recognition modules, including appropriate encoding, decoding, and compression algorithms, are those understood by those of ordinary skill in the art. The system 220 may also be equipped with security modules providing end-to-end security with other systems and intermediate host systems.

In one or more non-limiting embodiments, the network 250 may include a local area network (LAN), such as a company Intranet, a metropolitan area network (MAN), or a wide area network (WAN), such as the Internet or World Wide Web. The network 250 may be a private network or a public network, or a combination thereof. The network 250 may be any type of network known in the art, including telecommunications network, a wireless network (including Wi-Fi), and a wireline network. The network 250 may include mobile telephone networks utilizing any protocol or protocols used to communicate among mobile digital computing devices (e.g., user devices 210), such as Global System for Mobile Communications (GSM), General Packet Radio Service (GPRS), Universal Mobile Telecommunications System (UMTS), Advanced Mobile Phone System (AMPS), Time Division Multiple Access (TDMA), or Code Division Multiple Access (CDMA). In one or more non-limiting embodiments, different types of data may be transmitted via the network 250 via different protocols. In alternative embodiments, user devices 210 and the system 220, may act as standalone devices or may operate as peer machines in a peer-to-peer (or distributed) network environment.

The system 220 may also include one or more administrative entities (not shown). While the administrative entity may be a single element communicating over the network 250, the administrative entity may be distributed over the network 250 in any number of physical locations, in one or more non-limiting embodiments. The administrative entity may manipulate the software and enter commands to the system 220 using any number of input devices such as keyboard and mouse. The input/output may be viewed on a display screen associated with the administrative entity.

In some embodiments, the system 220 may allow the users 215 to place bets and receive payouts. The system 220 may be configured to provide data to the user devices 210, which may appropriately and dynamically change contents displayed on the user interface 225 to allow the users 215 with an interactive interface for placing bets. In some embodiments, the system 220 may be configured to provide contents and the interactable interfaces to the user device 210. In other embodiments, the interactable interfaces may be preloaded in the user device 210 (such as when the interactable interface is made available through a mobile application or software application accessible on a laptop or a desktop), and the system 220 may be configured to transmit data to the user device 210 to update the interactable interface.

For example, the interactable interface may allow the users 215 to register to become a registered user associated with the system 220. The system 220 may be downloadable and installable on the user device 210. In one or more non-limiting embodiments, the system 220 may be preinstalled on the user devices 210 by a manufacturer or a designer. In other embodiments, the system 220 may be implemented using a web browser via a browser extension or plugin. The system 220 may associate the user devices 210 with an account during the registration process.

Upon initially signing up with the system 220, the users 215 may be prompted to provide an email address. After entering an email address, the users 215 may be presented with a text window interface whereby the users 215 may enter their name, username, password, phone number, and address, among other information. In one or more non-limiting embodiments, location of the users 215 may be verified by the system 220 using GPS capabilities of the user devices 210 for verification to accommodate for various state legal systems. The system 220 may generate a code that is transmitted to the user's selected email or the user device 210 by text message whereby the users 215 may verify their account by entering the generated code into a text block window. The users 215 may be prompted to provide some personal information along with a requested account name and password, such as, without limitation, their name, age (e.g., birth date), gender, interests, contact information, home town, and address.

In some embodiments, when registering a user account, the system 220 may allow the users 215 to access and interact with the system 220 using login credentials from other social networking platforms. For example, in some embodiments, it may be useful and convenient for users 215 of the system 220 to be able to log in using credentials or sign in information from another social media application, such as Facebook® or Instagram® or the like. This is advantageous for users 215 who do not wish to have to remember or provide multiple types of login information.

The users 215 may be requested to take pictures of themselves whereby the system 220 collects and stores pictures of each user 215 in a database 224 to display to other users, for example, through the user interface 225. Pictures may be for identification purposes during navigation of a session and to enhance the authenticity of the process by ensuring that the picture is of the correct, intended user 215 when interacting with other users 215. The users 215 may couple, link, or connect with user accounts from social networking websites and internal networks. Examples of social networking websites include, but are not limited to, Instagram®, Facebook®, LinkedIn®, Snapchat®, and Twitter®. The system 220 may use access tokens or other methods as a parameter for searching for a friend list or address book of the users 215 on a social networking site or other site. The system 220 then may use this friend list information to initialize a contact list database for the users 215 stored within the system's databases.

The users 215 may opt-in for various notifications to be transmitted by the system 220. The users 215 may opt-in to allow the system 220 to notify them when certain events occur, such as events related to other users 215 and any of their syndicates. In further embodiments, the users 215 may establish one or more different profiles.

In some embodiments, the system 220 may generate notifications in the form of synchronization messages, such as an email message, text message, or calendar invitation for each user 215 related to the hot zones or special events causing the hot zones or special events to be included in a local personal information manager application connected to the system 220, such as Microsoft Outlook and Google Calendar. In one implementation, the synchronization message may include a calendar data exchange file, such as an iCalendar (.ics) file in compliance with Internet Engineering Task Force (IETF) Request for Comments (RFC) 5545.

The system 220 may allow the users 215 to place bets to compete for ranks with other users. The users 215 obtaining a certain rank or higher may become eligible for obtaining payouts. In some embodiments, the users 215 may compete for ranks individually, and in other embodiments, the users 215 may compete in groups or syndicates. The interactive interfaces provided by the system 220 may allow the users 215 to indicate the manner of competing, i.e. either individually or as part of the syndicate. In one or more non-limiting embodiments, the users 215 may search for a syndicate to be associated with the intent of joining the syndicate whereby the users 215 may create syndicate entries that can be used in tournaments or contests. The users 215 may also be presented with options to create a syndicate of which other users 215 may join. The syndicates may come from an existing database stored on the system 220 or a third-party database that the system 220 is in communication with, whereby the system 220 may receive results from a third-party connected database. The user interface 225 may present to the users 215 a search window whereby a search request having a character string may be entered, where one or more syndicates may be identified using name or other metadata pertaining to the users 215 or friends of the users 215.

As discussed, the users 215 have the ability to create syndicates of invited users for the purpose of forming syndicate entries having bets (through electronic bet slips) that can only be submitted by users within the syndicate. To start a group, a user 215 must invite users and the users 215 must agree to join the syndicate. In some embodiments, the users 215 may only join a syndicate if they are invited by an existing member of the syndicate. If syndicate members are to participate in monetized syndicate entries, they must be using the system 220 while being located in a geographic region where such forms of sports betting are legal, for example. Once a syndicate is formed, participants of the syndicate have the ability to start and join syndicate entries that are limited to players within the syndicate.

The users 215 may invite other users 215 or be invited by other users to connect to a syndicate via the system 220. When one user 215 has a connection with another user 215 on a syndicate, the connected users 215 may be able to communicate with the other user 215 as well as receive the connected user's 215 messages, picture, videos, and other content in the syndicate personalized content feed as well as video chat and texting chat communication utilizing the modules 208 of the system 220. In some embodiments, the system 220 may automatically connect two users 215 based on user specifications and criteria whereby a random syndicate may be created. Settings regarding communications by the users 215 may be modified to enable the user 215 to prevent the system 220 from automatically connecting the user to another user or letting another user follow the user, or letting another user message the user, as well as other settings.

The system 220 enables the user 215 to manage an existing bankroll, using the payments and settlement module 218. The payments and settlement module 218 may be configured to communicate with payment and settlement entities 240 to make payments to and receive payments from the users 215. For example, the entry fee or stake to be paid by the user 215 may be received by the payment and settlement entities 240. When the payment for the stake is made by the user 215, the payment and settlement entities 240 may transmit a signal in the form of an API call or a web hook to inform the system 220 that the payment has been made.

In some embodiments, the users 215 may be provided with a digital wallet, which may provide electronic representations of value of money/currency in possession of the users 215, which the users 215 can use for entering into further contests. The users 215 add and withdraw money to their bankroll/digital wallet to ensure they have sufficient funds to cover their bets. The users 215 may be prompted through the user interface 225 to input their credit card or debit card information, or using any card known in the art including, without limitation, an ATM card, a VISA®, MasterCard®, Discover®, or American Express® card in a credit card input field, or can alternatively use PayPal®, Squarepay®, Cryptocurrency or the like. Once the transaction has been approved by the third-party servers 230, funds are added to the personal account of the users 215 on the system 220. If there are insufficient funds, a rejection may occur when the user 215 attempts further payments (such as entering into another contest), wherein the rejected transaction is logged in the databases 224 of the system 220 and the users 215 may be presented with the rejection notification through the user interface 225. In such a scenario, the users 215 may attempt another transaction. Once approved, a value corresponding to the funds may appear on the home page. In a similar manner, the users 215 may withdraw funds to their credit cards or banking accounts or cryptocurrency accounts.

The user interface 225 may provide the ability to obtain one or more images of the credit card associated with the financial transaction. Images of the credit card may be captured by camera on the user device 210 whereby the system 220 may access the images. Images may include a front image of the credit card and a back image of the credit card. The system 220 may collect and store pictures of one or more credit cards of each user 215 in databases 224 for subsequent use. In some embodiments, images and the extracted details of the credit card may be deleted from the memory immediately or shortly after a transaction has been completed or terminated, while in further embodiments, temporarily stored credit card data may be encrypted and compressed for added security and stored on databases 224 for subsequent use whereby the user interface 225 may allow the users 215 to select from previously used credit cards.

In some embodiments, the system 220 may utilize a blockchain module (not shown) for the storage of transactions, the blockchain representing the completed transaction, whereby the users 215, depending on the privacy settings, may view the complete history of betting for record keeping purposes. Construction and storage of a blockchain allows to quickly and efficiently validate or access data using a series of connected devices that record the same event or transaction, thereby improving the safety of transactions. The storage of the blockchain continues by obtaining a historical block identifier of the historical blockchain. Once the various pieces of information have been collected, a validity requirement based on the transaction may be calculated whereby if the validity requirements are met, the historical blockchain may be updated.

Upon successful registration, an interactive page indicative of the home page may be generated by the system 220 on the user interface 225 using information stored on databases 224, whereby the home page may be visible to user 215. Home pages may be modified, written to, or otherwise administered by the respective user 215 for customization. The system 220 may also modify or delete a home page, for example, as a result of inactivity or inappropriate action on the behalf of the users 215.

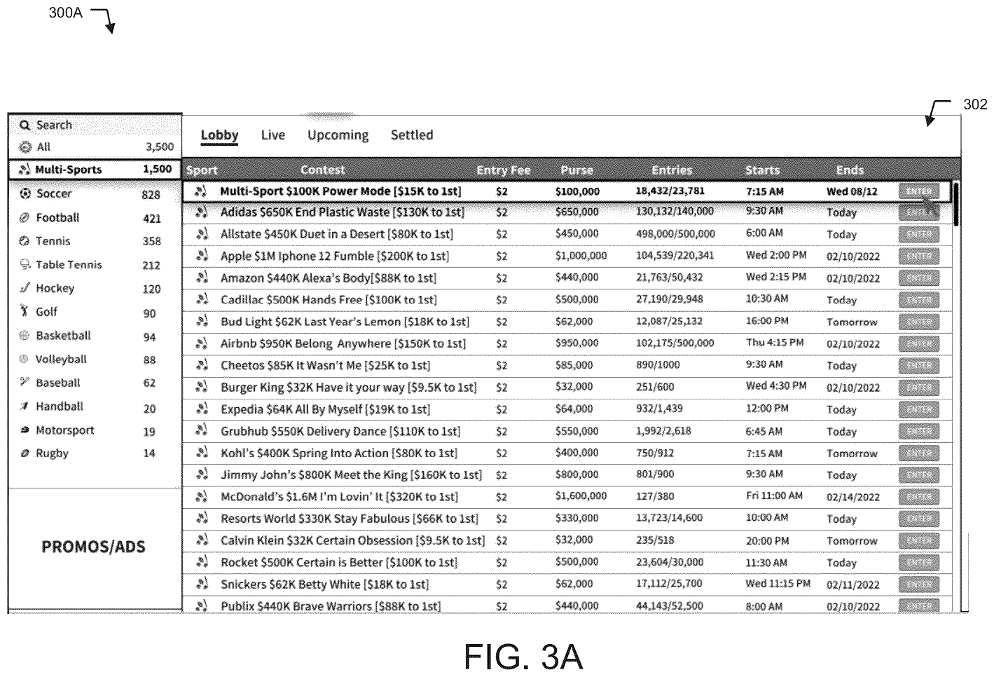

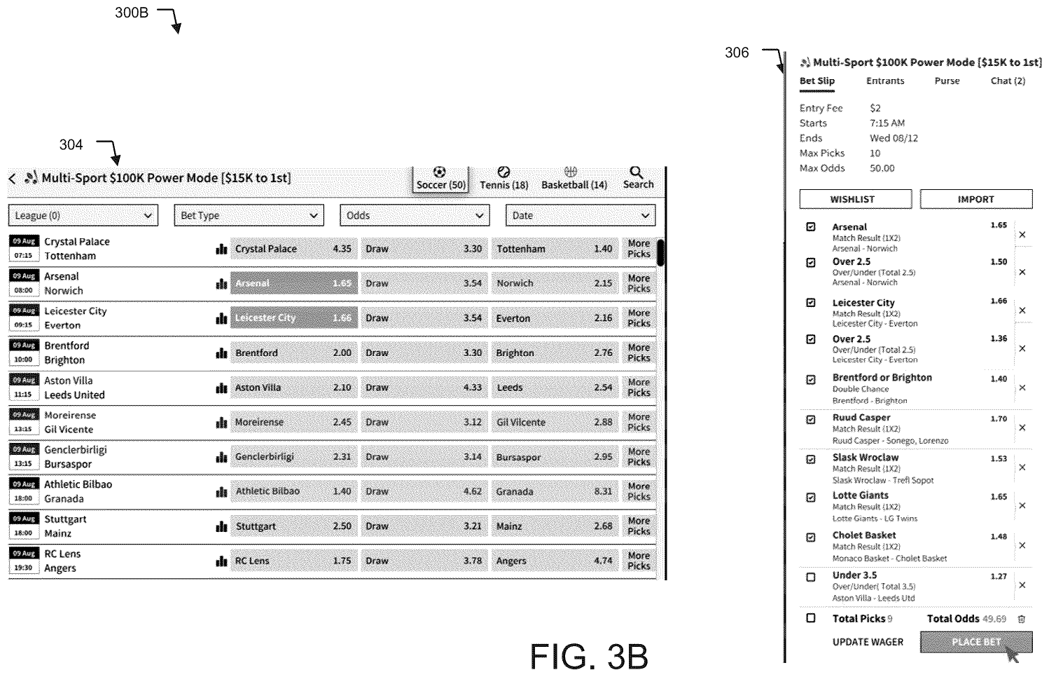

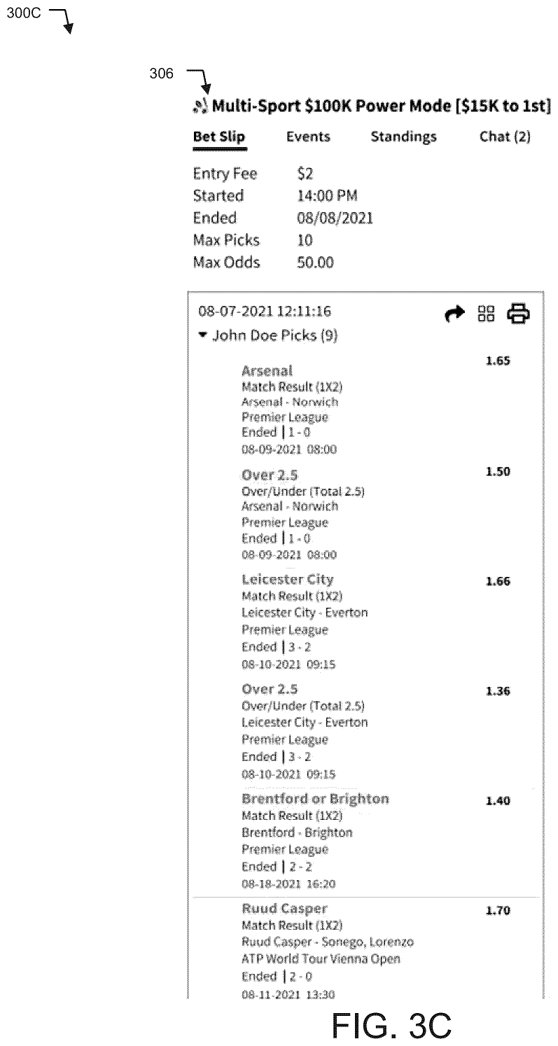

The home page may include a number of different subpages viewable or accessible by selecting one or more tabs presented on the user interface 225. When viewing the home page on the user interface 225, the users 215 may select one of the multiple contests presented on the interface to create a bet slip to compete against one or more other users 215. In some embodiments, the contests may be generated or retrieved by the contest creation module 212, where each contest is associated with one or more events. In some embodiments, the contests may be generated automatically, or by operators of the system 220. The events might be selectively chosen and added to the list of contests available for betting within the contest lobby 302 (as shown in user interface 300A of FIG. 3A). In other embodiments, the system 220 may be configured to receive or retrieve events information from the third-party servers 230. Electronic representations of the events may be retrieved synchronously. In further embodiments, events for contests may be created by the users 215, who may set their own rules and form private leagues.

The events may be of several types. In some examples, the events may correspond to sporting events, such as tennis, football, basketball, and the like. In other examples, the events may correspond to aspects/statistics of the sporting event, such as number of winners hit by a tennis player in a match, or number of goals scored. The events may also correspond to virtual gaming, where the users 215 may create bet slips for virtual sports events and compete against other users 215. The events may also correspond to various scenarios such as election outcomes, television (TV) award shows, sports teams' draft picks, and the like, where users 215 compete against other users 215 by creating bet slips with odd picks. The contests may allow users 215 to participate in a progressive jackpot contest. In these contests, users 215 may be provided with an odds value target. The contest pool funds continue to accumulate until one of the users 215 meets the odds value target and wins the jackpot. The system 220 may also randomly pair two users 215 for a tournament that involves multiple contest rounds. For example, each user 215 may receive 3 points for a win and 1 point for a tie, and when the tournament is concluded, the system 220 adds up each of the users 215 winning points and cumulative odds predictions to establish the tournament ranking. Further, the system 220 may allow free-to-play contests where users 215 compete for a chance to win sponsored prizes at no cost.

The events may have two or more possible outcomes associated therewith. In some embodiments, the events may correspond to or be related to sporting events, such as a soccer game, or a tennis match. In some embodiments, events may correspond to aspects associated with the event, such as number of goals scored in the soccer game, or number of winners hit by a player of the tennis match. The sporting events may take place in real-world, virtually as in e-sports, or simulated with computer programs. In other embodiments, the events may correspond to non-sporting events, such as in award shows, TV shows, game shows, live events, politics, and the like.

For generating or retrieving the contests, the events may be identifiable using corresponding data structures. The data structure may be indicative of dictionary having a plurality of attributes associated therewith, such as a type attribute indicating the type of event (such as a tennis match for example), an entity attribute indicating entities involved in the match (such as players of the tennis match), an outcome list attribute (such as a list of possible outcomes like player 1 winning, or player 2 winning), a timing attribute (such as start and end times), etc. In some embodiments, the data structure may be populated automatically using artificial intelligence engines configured to extract the attributes from at least one of video feeds, audio feeds, textual feeds, log information, and the like. In other embodiments, attributes of the data structure may be populated by a human entity, and may be accessed using electronic means in (near) real-time (such as through API calls) and processed by the system 220 for generating the contests. The data structure (and/or attributes thereof) for representing the events may be selected based on the requirements and nature of events.

Further, contests may be represented using data structures indicative of collections of event data structures. The data structure representing contests may further include attributes such as maximum odds value, maximum allowable picks/selections of events, maximum participant limit, minimum participant limit, start and end times of the contest, an identifier, and the like. Representing the contests and the events may allow computing systems (e.g., 220) to recognize and process data therein for automatically settling bets.

The contests may be generated/retrieved, and the system 220 may synchronously transmit, over the network 250, the contests to the user devices 210 operated by the users 215 for display on the user interface 225 of the user devices 210. The contests may be generated and transmitted in real-time. The contests may be transmitted using a data structure which may be parsed and displayed on the user interface 225 (such as on the user interface 300A). In an example, user interface 225 may parse the data structure and display the contests on the lobby 302 as shown in FIG. 3A. The user interface 225, among displaying other artifacts, may act as a primary control center for personal content, betting play, and communications. The user interface 225 may present, among other details, the individual or syndicate identifier (ID) currently selected, whereby a drop-down menu (not shown) may appear where the users 215 may switch between their individual profile or existing syndicate profiles. The user interface 225 may also allow the users 215 to view any chats, texts, or video conversations between syndicate members or other users 215. The user interface 225 may also include a bet-board (not shown) where the users 215 may review or make notes on upcoming contests, allowing for convenient research and customization when creating bet slips. Further, the user interface 225 may display the current standings of each user 215 in active tournaments or other competitions. The users 215 may view their individual and syndicate betting selections statistics (not shown) including how each user 215 in the syndicate is performing in the user interface 225. Further, the user interface 225 may also allow the users 215 to view and analyze their individual and syndicate betting selections history.

As discussed, the user interface 225 may include a chat tab for displaying a chat messaging interface to the users 215. In one or more non-limiting embodiments, the chat messaging interface (not shown) displayed to the users 215 may provide controls through the user interface 225 that allow users 215 to establish a chat session with other users 215. After selecting the chat tab, the users 215 may also be presented with a list of current chats with other users 215. Different options may be presented for the users 215 within the same syndicate including a chat room for just syndicate members whereby the users 215 may be placed in a video conference or a chatroom to discuss strategy for future bets or other topics.

An arena window may be presented through the user interface 225 where the users 215 may use the user interface 225 to filter lobby 302 for contests they want to bet on. The users 215 can even save their favorite teams or players for easy instant search to the upcoming contests they are in. The users 215 may also create a bet slip to scan for upcoming contests that best match the bet slip. A selectable filter button for tournaments on the arena window may be presented whereby the users 215 may see what contests/tournaments are available for playing. Once user 215 sees a contest/tournament they wish to participate in or inquire for more information, they may select the contest/tournament name to review contest details.

Tournaments and contests may also be selected based on any number of parameters such as, but not limited to, the entry fees of the tournament or contests, the types of sporting events and the provided odds markets, the start and end time, the prize-paying structure, the available and/or maximum user entries, and the maximum odds value or payouts. In some embodiments, each of the contests may have a maximum picks value and a maximum odds value associated therewith, and wherein the processor 202 may be configured to accept the one or more electronic bet slips based on, but not limited to, a product of the odds values associated with the predicted outcome of each of the subset of events being less than the maximum odds values, and a number of events in the subset of events being less than the maximum picks value. In an example, the users 215 total number of picks (i.e. predicted outcome for the subset of events) and the product of odds values for all the picks must be less than or equal to 10 picks and 50 odds, respectively. However, this is non-limiting and may vary depending on the contest or tournament. In another non-limiting example, the users 215 may select a tournament or contest where they may participate as an individual or a syndicate.

The user interface 225 may organize contests according to the entry fee. A user 215 may click on a preferred contest through the user interface 225 to display upcoming contests for the entry fee listed under each sponsor's logo. Once the users 215 have determined which tournament or contest they wish to participate in, users 215 may be presented with a plurality of sporting events and outcomes including, but not limited to, futures, money line props, point props, player props, over/under, and other odds markets. The tournament contest drop-down allows the users 215 to view and select a subset of events available inside tournament contests rounds. Furthermore, tournaments and contests may span any number of sporting events or games or time intervals, including but not limited to a week or an entire season.

The user device 210 may receive one or more inputs from a user 215 through the user interface 225 for generating one or more electronic bet slips, where each of the electronic bet slips includes a predicted outcome for a subset of events from the events associated with the contests, and an odds value associated with the predicted outcome of the subset of events. Once the users 215 decide to participate in a tournament or contest from their individual profile, they click the contest enter button and begin picking sporting events odds to fill up their bet slip (such as using the user interface 300B of FIG. 3B, where an events window 304 and a bet slip window 306 are shown). The users 215 may be notified of the increasing value of their total bet slips odds as they add new sporting events odds, the value of each event odds, average selected odds value, and any fluctuations in odds chosen value, so they may immediately decide whether to have a specific event odds remain in their bet slip or have it removed. The bet slip 306 remains open for the users 215 to add or remove event odds until they click the place bet button. After the users 215 decide on their final picks, the number of selections and total odds points displayed close to a place bet button must be less than or equal to, for example, 50 Max odds and 10 Max selections for the bet slip 306 to be accepted.

In such embodiments, the system 220 relieves the house/operators from constantly adjusting odds based on new information, either before the event or in real time, thereby eliminating the need to protect their liability. By altering the odds values that the users 215 add to their electronic bet slips, the system 220 deters users 215 from choosing a specific odds value. In such embodiments, the incentive for the system 220 to adjust odds may be to minimize tie scenarios that could arise from multiple users submitting identical bet slips to a contest. The system 220 may adjust the odds by using a machine learning algorithm, or using other heuristic algorithms known to those skilled in the art. Such algorithms may monitor the odds that are most popular among users 215 and decrease their value based on high demand. Conversely, such algorithms may increase the value of odds that users 215 are not selecting. Further, this action avoids a concentrated selection of the same odds value and eliminates the need for employing prediction algorithms otherwise used by existing fixed odds betting applications, thereby significantly reducing computational resources. The system 220 allows the odds to be determined based on user speculation, instead of requiring complex prediction algorithms.

Existing methods for adjusting odds value involve identifying probabilities associated with the event. Depending on the complexity of the dataset and the algorithm used, computing these probabilities can have a significant time complexity, potentially polynomial or higher. For instance, existing fixed odds betting solutions may use complex algorithms to monitor changes in public sentiment, injury, suspension news, and other data related to a particular event, based on which the odds may be determined. Complex datasets also have to be analyzed to determine odds values, among other parameters, in a manner that minimizes operator risk or operator liability. Such algorithms are often required to be run in real time. However, since the system 220 adjusts odds based on user's estimations of the odds in the electronic bet slips 306 instead of using diverse and complex algorithms, the system 220 may be able to operate with significantly lower computational expenditure. In some embodiments, the system 220 may be configured to set the odds as a function of the odds value determined by the users 215 to deter user selection concentration, it requires no complex processing. For instance, if many users 215 pick Manchester City to win against Dortmund at 1.40 odds, the system 220 may reduce the odds to 1.32. This avoids an overconcentration of user picks on Manchester City winning against Dortmund at 1.40 odds. However, such operations also consume minimal computational resources. Therefore, the system 220 may potentially settle bets with a constant time complexity, thereby allowing the system 220 to be easily scaled, and prevent failures/downtimes due to overloading.

The user device 210 may then transmit the electronic bet slips 306 to the system 220. The system 220 may receive and process the electronic bet slips 306 received from multiple users 215 in real-time, as and when the bets are placed. The bet slips 306 may be transmitted in a data structure, such as those similar to JavaScript Object Notation (JSON) or extensible Markup Language (XML). The bet slips 306 may be accepted by the system 220 when they are received between the start time and the end time of the selected contests. Further, the system 220 may be configured to accept those electronic bet slips 306 for which an entry condition associated with the one or more contests is satisfied. In some embodiments, the entry condition may be indicative of payment of a minimum entry fee. In further embodiments, the entry condition may be indicative of a tier associated with the user 215, the tier for the users 215 being determined based on previous success of users.

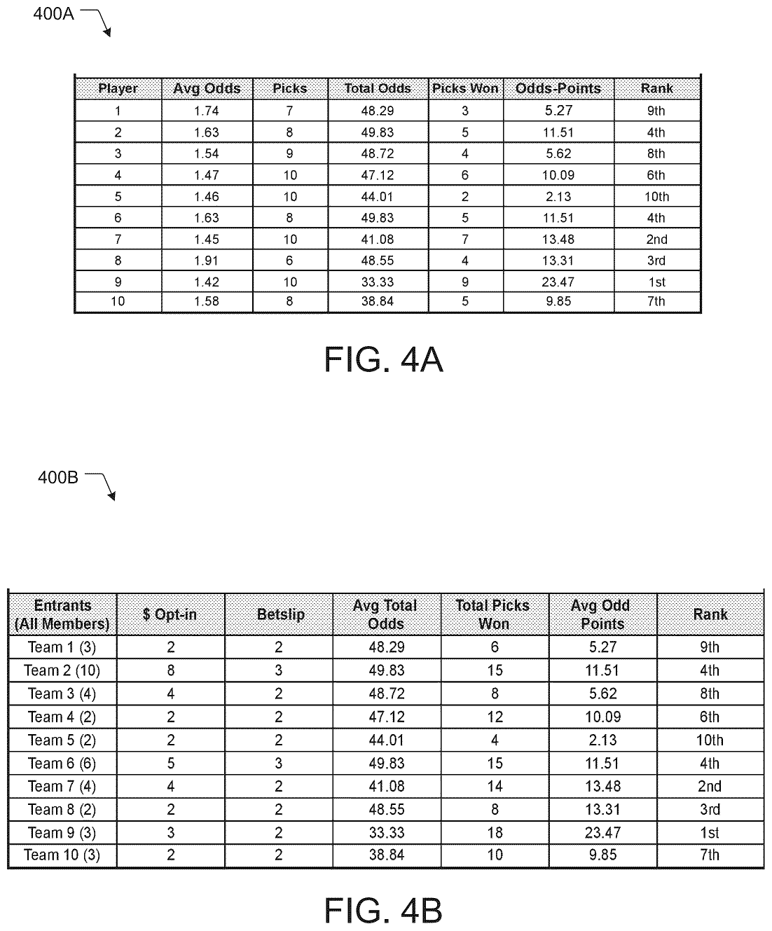

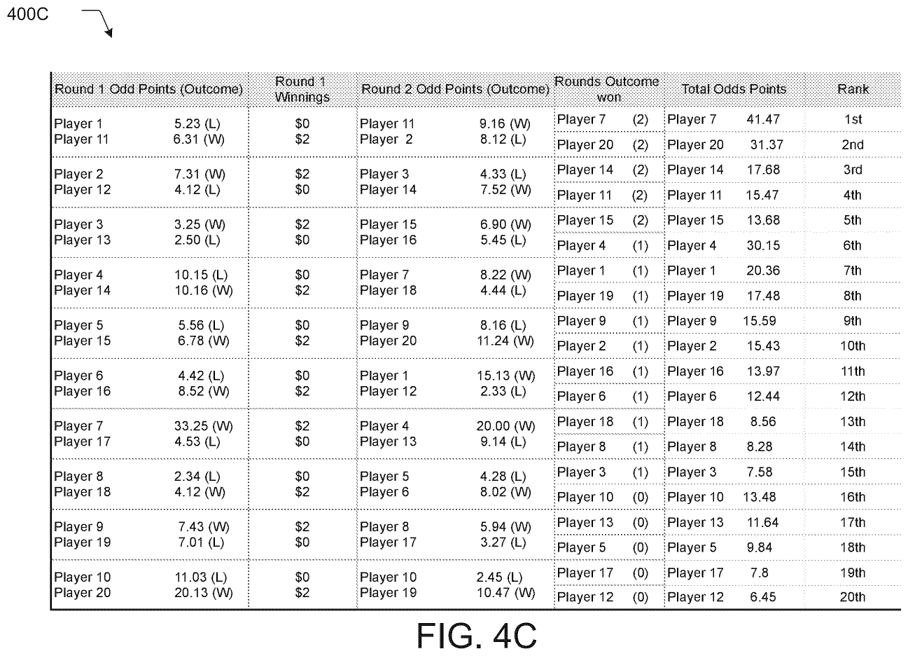

The bet slips 306 may be received and processed by the bet slip processing module 214. The bet slip processing module 214 may aggregate the bet slips 306 received from the user devices 210, and organize them in a table. The table may then be transmitted back to the user devices 210 to allow the users 215 to view other competitors in the contests, and view their ranks/performance in real-time. The table (such as 400A, 400B, 400C shown in FIGS. 4A to 4C), may be displayed on the user interfaces 225.

On conclusion of each event from the one or more events associated with the contest, the system 220 may determine/verify an actual outcome of the event based on electronic representation of the events in real-time or near real-time. The verification module 216 may be used to determine/verify the outcome of the events. In some embodiments, the electronic representations may be any one or combination of live video streams/feeds, audio streams, API calls or web hooks, signals transmitted by organizers of the events, one or more servers that process the aforementioned elements, the third-party servers 230, and the like. For example, bets may be placed on analytics associated with an event, such as the number of winners hit by a tennis player in a match. The system 220 may receive the electronic representation either in raw form or in a prepopulated data structure, and determine the actual outcome of the event using the electronic representation. For example, when the system 220 receives the electronic representation in the form of a video feed, the system 220 may use AI models associated with the video module to analyze the video feed and determine the outcome. In other embodiments, the electronic representations may be in the form of pre-populated data structures, such as when a broadcaster or event organizer uses electronic devices to track the score that are accessible to the system 220 using API calls or web hooks.

After determining the actual outcome of the event, the system 220 may be configured to determine a final odds value for each of the electronic bet slips 306 based on the predicted outcome matching with the actual outcome of the events. In some embodiments, to determine the final odds value for each of the electronic bet slips 306, the system 220 may be configured to determine the final odds value as a product of the odds value for each event where the predicted outcome matches with the actual outcome. Existing fixed odds betting systems, such as those that use fixed odds betting, continue to compare predicted and actual outcomes for all events, even when a single incorrect prediction results in a failed multi-prediction bet. For example, in a 10-leg accumulator bet, where the user must accurately predict all outcomes, and if the first prediction is incorrect, the existing fixed odds betting systems still process the remaining nine predictions, even though the final odds value has already been decided (i.e. reduced to 0) at the first incorrect prediction. The computational resources used to process and store these redundant results are wasted, as they are not used for any other purpose. However, the system 220 described in this disclosure uses these results to rank users 215, a feature not found in fixed-odds betting systems, thereby optimizing/maximizing memory utilization.

The system 220 of the present disclosure, however, uses the results to determine/assign ranks to the users 215, which are otherwise not utilized by the existing fixed odds betting systems. The system 220, hence, maximizes the utilization of memory. In the foregoing example, when the predicted outcome does not match with the actual outcome of an event, the system 220 may determine the final odds value as the product of the predicted odds value of the remaining events (i.e. the system 220 ignores the predicted odds value for the events for which the users 215 incorrectly predicted the outcome).

In some embodiments, the bet slips interface 306 may be updated in real-time as and when each event is concluded. Initially, the bet slips may indicate the total potential winnings, i.e. the odds value (being the product of odds values selected for each of the subset of events). When the predicted outcome matches the actual outcome for the event, no change is made to the potential winnings. If the predicted outcome does not match with the actual outcome for the event, then the potential winnings is reduced by a factor equal to the predicted odds value for that event. FIG. 3C illustrates a user interface 300C after actual outcomes for all events have been determined. As shown, the potential winnings of the user 215 may be reduced by factors of 1.5 and 1.4 for the two incorrectly predicted outcomes.

After actual outcomes of all events have been determined, the system 220 may be configured to assign a rank to each of the users 215 based on the final odds value of their corresponding electronic bet slips 306. The system 220 allows the users 215 to compete against each other for ranks. In some embodiments, payouts may be executed to the users 215 having a rank satisfying a prize paying position. For example, payouts may be issued to users 215 having ranks 3rd or higher. By making users 215 to compete for ranks, the system 220 eliminates the need for match-making algorithms that are used in existing peer-to-peer betting/gaming application(s), thereby reducing the computational load on computing devices implementing the system 220.

In some embodiments, the system 220 may be configured to execute a payout (such as using the payments and settlement module 218) to a subset of users from the users 215 having the rank satisfying the prize paying position associated with the contests. The prize paying position may be satisfied for the users 215 based on, but not limited to, the rank corresponding to a user being greater than a rank threshold and the final odds value being greater than a predetermined odds value threshold. Other conditions may be imposed for determining whether the users 215 satisfy the prize paying position, and by implication whether they are eligible for payouts.

The payouts may be issued in the form of electronic transfer of money/value. In some embodiments, the system 220 may transmit signals (such as through API calls or webhooks) to servers/computing devices operated by the payment and settlement entities 240. For example, the system 220 may transmit an API call to a payments partner for transfer of electronic representations of money to the winning users 215. In other examples, the system 220 may be configured to mint and/or transfer tokens (such as cryptocurrency) to the winning users 215 as payouts. In further examples, the system 220 may transfer credits/tokens to digital wallets associated with the winning users 215, which may either be withdrawn, encashed, or used for making payments to in-house or third-party e-commerce entities. In some embodiments, the payouts may have vig or commissions deducted for each contest/transaction, as required by operators of the system 220.

The system 220, hence, minimizes the computational expenditure required by eliminating the need to monitor multiple datasets to adjust operator liability, and offloading calculation of betting odds to the users 215. Further, every computation performed by the system 220 is utilized, and not wasted, for providing a betting interface to the users 215 (such as by utilizing information on actual outcomes of the events, even when outcomes are predicted incorrectly by users 215, unlike in case of existing fixed odds betting systems). The number of updates required also reduces to the number of events, i.e. transmit updates to user devices 210 when the actual outcome of the events is determined (as opposed to predetermined intervals for updating the odds in real-time in case of existing fixed odds betting systems). The system 220 also simplifies risk management by making users 215 compete against each other, and eliminates the need to manage exposure, liabilities, or hedging, which is required in existing fixed odds betting systems, thereby reducing the use of computational resources. Due to the aforementioned advantages, the system 220 may be easily scaled to meet increased user demands, and lower the chances of failures.

A sample contest 400A is illustrated in FIG. 4A with a contest having 10 participants whereby all the users 215 strategically make their picks to get close to a max odds of 50 and maximum selections of 10. Column 1 shows the number of the users 215 in the contest. There are no limitations on the maximum number of the users 215 in a contest, but a contest operator may introduce limits to manage contest operations. Column 2 illustrates the average of the two or more odds selected by the users 215. While making picks, the users 215 may choose any available odds from 1.01 to 50.00, giving each user 215 the freedom to choose any odds value that suits their preference. For example, the table associated with the sample contest 400A shows player nine accumulated low-valued odds while player eight chose high-valued odds.

Column 3 shows the number of picks. The number of selections is dependent on their average odds. For example, any average odds above 1.47 would exceed the maximum odds of 50, and hence the users 215 may need nine or fewer selections to be accepted into a contest. Column 4 shows the total odds that the users 215 submitted for the competition. The value of the total odds that the users 215 present in a contest is the maximum odds points they can score in a contest or tournament. Column 5 shows the number of picks won by the users 215. Losing picks reduce the users 215 total odds (i.e. shown in Column 4), and every winning selection increases the chances of finishing in a prize-paying position. Column 6 shows the odds points that the users 215 won out of their initial total odds. The winning odds point is used to determine a player's rank. When two or more players tie in a place, the related pool positions may be evenly split among each player, in some examples. Column 7 shows the ranking of winning odds points in descending order. The system 220 may then determine one or more winners based on their rank.

In some embodiments, two or more users 215 may form a syndicate on satisfying a payment condition for contest entries. In other embodiments, the users 215 may start a syndicate and define the parameters for membership or join an existing syndicate created by another user 215. In other embodiments, one or more syndicate members may submit a bet slip for a syndicate contest entry, whereby only the users 215 on the syndicate that satisfy the payment condition for the contest are rewarded with a share of winnings. This may be a good option for a group of the users 215 that may like to participate in many contests but need the help of other users 215 to bear the risk of losing.

Starting a syndicate profile allows the users 215 to specify the settings for their syndicate membership. For example, a user 215 indicative of a syndicate manager, may decide to keep and/or share authority with other users 215 to decide on the tournament or contest that the syndicate should play. A syndicate contest or tournament entry begins when a syndicate manager or an authorized user 215 of a syndicate adds the contest or tournament to the syndicate bet board or submits a bet slip into the contest or tournament. The bet board helps each user 215 of a syndicate to contribute a bet slip or share notes with other syndicate users 215 on an upcoming contest. The system 220 may make each syndicate member's bet slips available for other users 215 to see. The users 215 of a syndicate are notified as the bet slips 306 from its members are added and removed from the syndicate. A syndicate's bet slips remain open for editing until a designated number of the users 215 have agreed and can satisfy the payment conditions for contest entry fees. The syndicate manager or authorized user 215 makes a syndicate final contest submission. The users 215 that present a bet slip for a syndicate contest entry are required to satisfy the payment condition for a syndicate contest entry.

The syndicate that the users 215 belong to or are using to place bets may be indicated in the bet slips 306. The electronic bet slips 306 may include a syndicate attribute indicative of a syndicate/group of users, or an ID thereof. When the system 220 receives multiple bets slips with the syndicate attribute, the system 220 may be configured to group the one or more electronic bet slips into one or more syndicates based on the syndicate attribute. In some embodiments, for each event in the subset of events selected in the electronic bet slips 306 received for each syndicate, the system 220 may be configured to determine the odds value of the event as an average of the odds values provided for the event in each bet slip associated with the syndicate.

For example, in a sample contest 400B illustrated in FIG. 4B, a syndicate contest may have 10 participants whereby all the users 215 strategically make their picks to get close to a max odds of 50 with a maximum number of selections of 10. There are no limitations on syndicate contest entrants unless constraints are applied to manage contest operation. At least two syndicate members must contribute an entry fee for a contest. Only members contributing their share of the entry fee are eligible to share contest winnings. In some embodiments, a first subset of the users 215 may be allowed to submit bet slips 306, while a second subset of the users 215 may contribute a share of entry fees without submitting a bet slip 306. In some examples, syndicate manager may be responsible for choosing a contest or tournament for their syndicate users 215. When two or more users 215 of a syndicate submit bet slips for a contest, the average of the total odds of their bet slips is used to determine their entry total odds. The average of the total winning odds from each bet slip when two or more syndicate members submits a bet slip is used to determine the syndicate ranking odds point. Once the system 220 determines a syndicate rank in a prize-paying position, funds are disbursed to the users 215 on the syndicate who created bet slips or other users 215 who paid the entry fee but did not create a bet slip or the overall team in a different fund. In some embodiments, the payout for the syndicate may be executed to each user in the syndicate in a predetermined ratio. In some embodiments, the payouts may be evenly distributed, such as when each user pays the same entry fee. In other embodiments, the payouts may be determined in proportion to the final odds value for each user at the conclusion of the contest.

In another embodiment, the system 220 may be configured to implement a bracket-style tournament. In such embodiments, the system 220 may be configured to allow users 215 to compete in one or more rounds. For each round associated with the one or more contests, the system 200 may be configured to generate one or more pairs of the users 215. Further, for each pair from the one or more pairs of users 215, the system 220 may be configured to determine an intermediate odds value based on the predicted outcome matching with the actual outcome of the one or more events for each user in the pair. In some embodiments, the intermediate odds value for each user is determined as a multiple of the odds value if the actual outcome matches with the predicted outcome in each round of the contest. For example, if a user (i.e. the winning user) has a higher intermediate odds value than their opponent in a contest round, they win 3 points for winning the contest, while the user (i.e. the losing user) with a lower intermediate odds value gets 0 points. In subsequent rounds, users 215 are paired randomly, in some examples.

In other examples, after determining the intermediate odds value in each round, the system 220 may be configured to identify the winning user and the losing user from the pair, where the intermediate odds value of the winning user is greater than the intermediate odds value of the losing user. In some embodiments, the winning user of each of the pairs in a preceding round may be paired with other winning users and the losing user of each of the one or more pairs in the preceding round is paired with other losing users. In other embodiments, other techniques may be used to generate the pairs of the users 215.

At the conclusion of all the rounds, the system 220 may rank the users 215 based on a number of rounds where each user is the winning user, and a sum/cumulation of the intermediate odds value (or the final odds value) of the user 215. The user 215 being the winning user in the highest number of rounds and having a cumulative intermediate odds score/final odds value greater than a predefined threshold may satisfy the prize paying position, in some examples. Other conditions may be introduced to determine if the user 215 satisfies the prize paying position of the tournament.

The aforementioned tournament format allows for the right balance of skill versus luck for the users 215, who may be either casual or sharp players. The tournament format matches the users 215 head-to-head against any other player within the same contest bracket. The first tournament round has a single bracket, and each next tournament round has a winner's bracket and a loser's bracket emanating from the outcomes of the last tournament round. In some examples, the tournament may include three or more tournament rounds; however, this is non-limiting and there may be any number of rounds. In such embodiments, the system 220 may determine reward by ranking precedence to the descending order of the users 215 that won the most tournament rounds. The descending order of the cumulative score or points from one or more tournament rounds is used afterward to determine the final tournament ranking.

As shown in example sample contest or tournament 400C illustrated in FIG. 4C, a tournament may have a $2 entry fee and 20 participants. In such examples, all players compete head-to-head in two rounds of play for each tournament that may be randomly assigned or predesignated based on previous rankings and outcomes. The goal is to outsmart opponents in a head-to-head contest. In the first round, players are paired automatically for a head-to-head contest. The tournament requires an even number of the users 215. A tie between two users 215 is considered a win for both the users 215, and both participants get back their entry fee. There are no limitations on tournament entries unless constraints are applied to manage contest operations. Winning users 215 in each round often get back their share of each contest round entry fee, whereas the entry fee of the losing users 215 goes towards the overall tournament purse. In the sample contest 400C, column 6 shows player 7 ranked 1^{st} for winning two tournament rounds and scoring the most cumulative tournament rounds winning odds. Even though player 10 almost had the same cumulative winning odds as player 16, their rank differed significantly due to the number of tournament rounds won. Rank highly depends on the total number of rounds a player wins. The total odds point which may be added up is used to determine a player's overall position. After the designated tournament contests have been completed, the system 220 determines and assigns ranking from the values of total rounds won from most to least number of opponents and cumulative winning odds from all rounds.

The users 215 may also be rewarded with game achievements based on mastering certain in-game facets. As used herein, “reward” refers to a graphical, audio, numerical, or other player notification event that occurs. A reward may be a positive indicator of accurate gameplay, such as an accrual of points or ranking, an indication of advancing to the next level that may be presented to other users 215. The system 220 may calculate and disburse payments or trophies as rewards to users 215 fulfilling requests, whereby the system 220 may indicate the payment to be provided to user 215 if user 215 performs a task.

In some embodiments, the system 220 may analyze and calculate data stored in the databases 224 whereby the user interface 225 may display collected results from the system 220 in the form of ranking leaderboards among the users 215 based on any number of parameters, including most wins in the month, most bets, most rewards won, and other rankings whereby the system 220 may further incentivize the users 215 on the leaderboards with advertisements, promotions, or notifications directed to attracting other users 215.

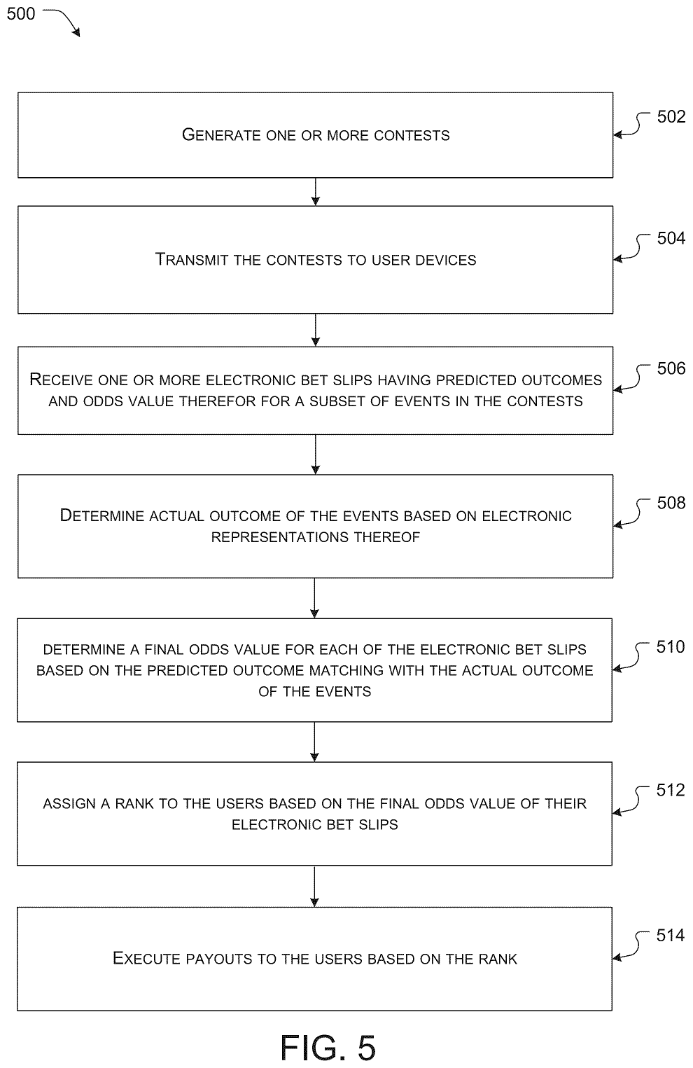

FIG. 5 illustrates an example flowchart of a method 500 for automated settlement of peer-to-peer bets. The method 500 may be implemented by the system 220.

At block 502, the method 500 includes generating, by a computing system such as the system 220, one or more contests, where each contest is associated with one or more events.

At block 504, the method 500 includes synchronously transmitting, by the computing system 220, the one or more contests to one or more user devices 210 operated by one or more users 215 for display on a user interface 225 of the one or more user devices 210.

At block 506, the method 500 includes receiving, by the computing system 220, one or more electronic bet slips from the one or more user devices 210, where each of the one or more electronic bet slips includes a predicted outcome for a subset of events from the one or more events selected by the one or more users 215, and an odds value associated with the predicted outcome corresponding to the subset of events.

At block 508, on conclusion of each event from the one or more events, the method 500 includes determining, by the computing system 220, an actual outcome of the event based on electronic representation of the event in real-time.

At block 510, the method 500 includes determining, by the computing system 220, a final odds value for each of the one or more electronic bet slips based on the predicted outcome matching with the actual outcome of the one or more events.

At block 512, the method 500 includes assigning, by the computing system 220, a rank to the one or more users 215 based on the final odds value of the one or more electronic bet slips corresponding to the one or more users 215.

At block 514, the method 500 includes executing, by the computing system 220, a payout to a subset of users from the one or more users 215 having the rank satisfying a prize paying position associated with the one or more contests. In some embodiments, the method 500 may be stored as instructions in a non-transitory computer readable medium, which may be executed by the computer system 220.

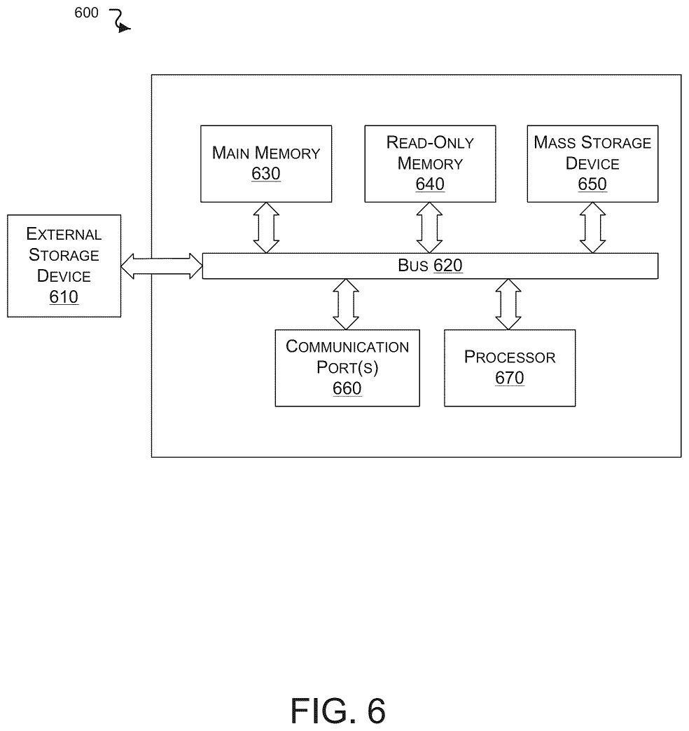

Referring to FIG. 6, the block diagram represents a computer system 600 that includes an external storage device 610, a bus 620, a main memory 630, a read only memory 640, a mass storage device 650, a communication port 660, and a processor 670. A person skilled in the art will appreciate that the computer system 600 may include more than one processor 670 and communication ports 660. The processor 670 may include various modules associated with embodiments of the present disclosure. The communication port 660 can be any of a Recommended Standard 232 port for use with a modem-based dialup connection, a 10/100 Ethernet port, a Gigabit or 10 Gigabit port using copper or fiber, a serial port, a parallel port, or other existing or future ports. The communication port 660 may be chosen depending on a network, such as a LAN, a WAN), or any network to which the computer system 600 connects.

In an embodiment, the memory 630 can be a RAM, or any other dynamic storage device commonly known in the art. The Read-Only Memory (ROM) 640 may be any static storage device(s) e.g., but not limited to, a Programmable Read-Only Memory (PROM) chip for storing static information. The mass storage 650 may be any current or future mass storage solution, which may be used to store information and/or instructions. Exemplary mass storage solutions may include, but are not limited to, Parallel Advanced Technology Attachment (PATA) or Serial Advanced Technology Attachment (SATA) hard disk drives or solid-state drives (internal or external, e.g., having USB and/or Firewire interfaces), one or more optical discs, Redundant Array of Independent Disks (RAID) storage, e.g., an array of disks (e.g., SATA arrays).

In an embodiment, the bus 620 communicatively couples the processor(s) 670 with the other memory, storage, and communication blocks. The bus 620 may be, e.g., a PCI/PCI Extended (PCI-X) bus, SCSI, USB, or the like, for connecting expansion cards, drives, and other subsystems as well as other buses, such a front side bus (FSB), which connects the processor 670 to the computer system 600.

In another embodiment, operator and administrative interfaces, e.g., a display, keyboard, and a cursor control device, may also be coupled to the bus 620 to support direct operator interaction with computer system 600. Other operator and administrative interfaces may be provided through network connections connected through communication port 660. In some embodiments, the external storage device 610 can be any kind of external hard-drives, floppy drives, CD-ROM, Compact Disc-Re-Writable (CD-RW), Digital Video Disk-Read Only Memory (DVD-ROM). Components described above are meant only to exemplify various possibilities. In no way should the aforementioned exemplary computer system 600 limit the scope of the present disclosure.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure.

The embodiments were chosen and described in order to best explain the principles of the disclosure and the practical application, and to enable others of ordinary skill in the art to understand the disclosure for various embodiments with various modifications as are suited to the particular use contemplated. The present disclosure according to one or more embodiments described in the present description may be practiced with modification and alteration within the spirit and scope of the appended claims. Thus, the description is to be regarded as illustrative instead of restrictive of the present disclosure.

What is claimed is:

1. A system for automated settlement of peer-to-peer bets, comprising:
a processor; and
a memory operatively coupled to the processor, wherein the memory comprises one or more processor-executable instructions which, when executed, cause the processor to:
generate one or more contests, wherein each contest is associated with one or more events;
synchronously transmit, over a communication network, the one or more contests to one or more user devices operated by one or more users for display on a user interface of the one or more user devices;
receive, through the communication network, one or more electronic bet slips from the one or more user devices, wherein each of the one or more electronic bet slips comprises a predicted outcome for a subset of events from the one or more events selected by the one or more users, and an odds value associated with the predicted outcome corresponding to the subset of events;
on conclusion of each event from the one or more events, determine an actual outcome of the event based on electronic representation of the event in real-time;
determine a final odds value for each of the one or more electronic bet slips based on the predicted outcome matching with the actual outcome of the one or more events;
assign a rank to the one or more users based on the final odds value of the one or more electronic bet slips corresponding to the one or more users; and
execute a payout to a subset of users from the one or more users having the rank satisfying a prize paying position associated with the one or more contests.

2. The system of claim 1, wherein the one or more contests have a start time and an end time associated therewith, the start time and the end time being determined based on the one or more events thereof, and wherein the processor is configured to receive the one or more electronic bet slips between the start time and the end time.

3. The system of claim 1, wherein the processor is configured to accept a subset of electronic bet slips from the one or more electronic bet slips for which an entry condition associated with the one or more contests is satisfied.

4. The system of claim 1, wherein each of the one or more contests have a maximum picks value and a maximum odds value associated therewith, and wherein the processor is configured to accept the one or more electronic bet slips based on:
a product of the odds values associated with the predicted outcome of each of the subset of events being less than the maximum odds values; and
a number of events in the subset of events being less than the maximum picks value.

5. The system of claim 1, wherein to determine the final odds value for each of the one or more electronic bet slips, the processor is configured to determine the final odds value as a product of the odds value for each event where the predicted outcome matches with the actual outcome.

6. The system of claim 1, wherein the prize paying position is satisfied for the one or more users based on at least one of:
the rank corresponding to a user being greater than a rank threshold; and
the final odds value being greater than a predetermined odds value threshold.

7. The system of claim 1, wherein the processor is configured to curate the one or more contests from one or more servers operated by third-party entities, and transmit the one or more contests for display on the user interface of the one or more user devices.

8. The system of claim 1, wherein the one or more electronic bet slips comprise a syndicate attribute indicative of a syndicate/group of users, and wherein the processor is configured to:
group the one or more electronic bet slips into one or more syndicates based on the syndicate attribute; and
for each event in the subset of events associated with the one or more electronic bet slips received for each syndicate, determine the odds value of the event as an average of the odds values provided for the event in each bet slip associated with the syndicate.

9. The system of claim 8, wherein the payout is executed to each user in the syndicate in a predetermined ratio.

10. The system of claim 1, wherein to assign the rank to the one or more users, the processor is configured to:
for each round associated with the one or more contests:
generate one or more pairs of users from the one or more users;
for each pair from the one or more pairs of users:
determine an intermediate odds value based on the predicted outcome matching with the actual outcome of the one or more events for each user in the pair; and
identify a winning user and a losing user from the pair, wherein the intermediate odds value of the winning user is greater than the intermediate odds value of the losing user; and
rank the one or more users based on a number of rounds where each user is the winning user, and a sum of the intermediate odds value of the user.

11. The system of claim 10, wherein to generate the one or more pairs of users, the winning user of each of the one or more pairs in a preceding round is paired with other winning users and the losing user of each of the one or more pairs in the preceding round is paired with other losing users.

12. A method for automated settlement of peer-to-peer bets, comprising:
generating, by a computing system, one or more contests, wherein each contest is associated with one or more events;
synchronously transmitting, by the computing system, the one or more contests to one or more user devices operated by one or more users for display on a user interface of the one or more user devices;
receiving, by the computing system, one or more electronic bet slips from the one or more user devices, wherein each of the one or more electronic bet slips comprises a predicted outcome for a subset of events from the one or more events selected by the one or more users, and an odds value associated with the predicted outcome corresponding to the subset of events;
on conclusion of each event from the one or more events, determining, by the computing system, an actual outcome of the event based on electronic representation of the event in real-time;
determining, by the computing system, a final odds value for each of the one or more electronic bet slips based on the predicted outcome matching with the actual outcome of the one or more events;
assigning, by the computing system, a rank to the one or more users based on the final odds value of the one or more electronic bet slips corresponding to the one or more users; and
executing, by the computing system, a payout to a subset of users from the one or more users having the rank satisfying a prize paying position associated with the one or more contests.

13. The method of claim 12, wherein the method comprises accepting, by the computing system, a subset of electronic bet slips from the one or more electronic bet slips for which an entry condition associated with the one or more contests is satisfied.

14. The method of claim 12, wherein each of the one or more contests have a maximum picks value and a maximum odds value associated therewith, and wherein the method comprises accepting, by the computing system, the one or more electronic bet slips based on:
a product of the odds values associated with the predicted outcome of each of the subset of events being less than the maximum odds values; and
a number of events in the subset of events being less than the maximum picks value.

15. The method of claim 12, wherein for determining the final odds value for each of the one or more electronic bet slips, the method comprises determining, by the computing system, the final odds value as a product of the odds value for each event where the predicted outcome matches with the actual outcome.

16. The method of claim 12, wherein the prize paying position is satisfied for the one or more users based on at least one of:
the rank corresponding to a user being greater than a rank threshold; and
the final odds value being greater than a predetermined odds value threshold.

17. The method of claim 12, wherein the method comprises curating, by the computing system, the one or more contests from one or more servers operated by third-party entities, and transmit the one or more contests for display on the user interface of the one or more user devices.

18. The method of claim 12, wherein the one or more electronic bet slips comprise a syndicate attribute indicative of a syndicate/group of users, and wherein the method comprises:
grouping, by the computing system, the one or more electronic bet slips into one or more syndicates based on the syndicate attribute; and
for each event in the subset of events associated with the one or more electronic bet slips received for each syndicate, determining, by the computing system, the odds value of the event as an average of the odds values provided for the event in each bet slip associated with the syndicate, wherein the payout is executed to each user in the syndicate in a predetermined ratio.

19. The method of claim 12, wherein to assign the rank to the one or more users, the method comprises:
for each round corresponding to the one or more events:
generating, by the computing system, one or more pairs of users from the one or more users;
for each pair from the one or more pairs of users:
determining, by the computing system, an intermediate odds value based on the predicted outcome matching with the actual outcome of the one or more events for each user in the pair; and
identifying, by the computing system, a winning user and a losing user from the pair, wherein the intermediate odds value of the winning user is greater than the intermediate odds value of the losing user; and
rank, by the computing system, the one or more users based on a number of rounds where each user is the winning user, wherein for generating the one or more pairs of users, the winning user of each of the one or more pairs in a preceding round is paired with other winning users and the losing user of each of the one or more pairs in the preceding round is paired with other losing users.

20. A non-transitory computer-readable medium comprising processor-executable instructions that cause a processor to:
generate one or more contests, wherein each contest is associated with one or more events;
synchronously transmit, over a communication network, the one or more contests to one or more user devices operated by one or more users for display on a user interface of the one or more user devices;
receive, through the communication network, one or more electronic bet slips from the one or more user devices, wherein each of the one or more electronic bet slips comprises a predicted outcome for a subset of events from the one or more events selected by the one or more users, and an odds value associated with the predicted outcome corresponding to the subset of events;
on conclusion of each event from the one or more events, determine an actual outcome of the event based on electronic representation of the event in real-time;
determine a final odds value for each of the one or more electronic bet slips based on the predicted outcome matching with the actual outcome of the one or more events;
assign a rank to the one or more users based on the final odds value of the one or more electronic bet slips corresponding to the one or more users; and
execute a payout to a subset of users from the one or more users having the rank satisfying a prize paying position associated with the one or more contests.
